(19) United States
(12) Patent Application Publication
(10) Pub. No.: US 2016/0065931 A1
(43) Pub. Date: Mar. 3, 2016

(54) Method and Apparatus for Computing a Synthesized Picture

(71) Applicant: Huawei Technologies Co., Ltd., Shenzhen (CN)

(72) Inventor: Jacek Konieczny, Munich (DE)

(21) Appl. No.: 14/937,046

(22) Filed: Nov. 10, 2015

Related U.S. Application Data
(63) Continuation of application No. PCT/EP2013/059941, filed on May 14, 2013.

(51) Int. Cl. H04N 13/00; H04N 13/02

(52) U.S. Cl. CPC H04N 13/0018; H04N 13/0011; H04N 13/0203; H04N 13/0296; H04N 13/0055; H04N 2013/0088; H04N 2213/005

(57) ABSTRACT

A method for computing a synthesized picture (s_{T}′) of a visual scene, the method comprising projecting the left depth map (s_{D,l}) into a left projected depth map (s_{D,l}′) and projecting the right depth map (s_{D,r}) into a right projected depth map (s_{D,r}′), and determining a left disoccluded area (s_{F,l}′) in the left projected depth map (s_{D,l}′) and a right disoccluded area (s_{F,r}′) in the right projected depth map (s_{D,r}′); detecting object border misalignments between the left projected depth map (s_{D,l}′) and the right projected depth map (s_{D,r}′); determining a left reliability map information (s_{R,l}′) based on the left disoccluded area (s_{F,l}′), and the detected object border misalignments, and determining a right reliability map information (s_{R,r}′) based on the right disoccluded area (s_{F,r}′), and the detected object border misalignments; and computing the synthesized picture.

### CROSS-REFERENCE TO RELATED APPLICATIONS

This application is a continuation of International Application No. PCT/EP2013/059941, filed on May 14, 2013, which is hereby incorporated by reference in its entirety.

### TECHNICAL FIELD

The present invention relates to a method and an apparatus for computing a synthesized picture of a visual scene, in particular in the field of computer vision, three-dimensional (3D) video processing and 3D video synthesis.

### BACKGROUND

3D video synthesis is utilized in applications that require rendering of a virtual view. This includes applications like Free-viewpoint Television (FTV) where the viewpoint can be selected according to the preferences of a viewer or, e.g., 3D video coding of a multiview video where some of the views are synthesized from others, increasing the compression of such content by limiting the number of views to be transmitted. In 3D video, view synthesis is a process of creating a virtual view based on the available reference views (physical views, herein also referred as texture views) from which the visual scene was acquired.

The most commonly used approach of view synthesis is so called Depth Image-Based Rendering (DIBR) method described by [L. McMillan, “An image-based approach to three-dimensional computer graphics”, Doctoral thesis, University of North Carolina, Chapel Hill, USA, April 1997] that utilizes depth maps defining the distance of scene points from the viewpoint in order to project the corresponding texture information into virtual view position.

A depth map can be defined as information describing the distance of each part of the visual scene, e.g., represented in form of a grayscale image; alternatively a disparity map can be used, which values are inverse-proportional to the ones represented by the depth map. Among DIBR-based synthesis methods two main approaches can be distinguished: forward- and backward-projection algorithms. In forward-projection, coordinates of each sample in the picture from the reference view are projected onto a synthesized picture, resulting in non-integer sample coordinates. This means that actual values of samples in the synthesized picture must be somehow estimated from the closest samples projected from the reference view. On the other hand, in backward-projection approach, coordinates of each sample in the synthesized picture are projected into a reference picture. Consequently, the value of the sample is determined based on the samples in the picture from the reference picture that are close to the position of this projected sample. Both methods differ in aspects like disoccluded area detection and handling, possibility of simultaneous scanning of more than one reference view to produce the synthesized output picture or required picture interpolation methods.

In the following sections, it is assumed that reference views are aligned horizontally, i.e., left and right reference views can be distinguished that are displaced in the horizontal direction. The most efficient state-of-the-art virtual view synthesis algorithms based on the DIBR methods rely on forward-projection algorithms that combine pictures synthesized from a left and right reference pictures in order to produce the synthesized output picture. The current state-of-the-art solution—the High Efficiency Video Coding (HEVC) Test Model adopted into Joint Collaborative Team on 3D Video (JCT-3V) (joint Telecommunication Standardization Sector of the International Telecommunications Union (ITU-T)/Moving Picture Experts Group (MPEG) standardization effort for 3D) as described by [H. Schwarz, K. Wegner, “Test Model under Consideration for HEVC based 3D video coding”, MPEG Doc. m12350, November 2011] uses a synthesis algorithm 100 as presented in FIG. 1.

In the algorithm 100 left and right view textures s_{T,l} and s_{T,r} and depths s_{D,l} and s_{D,r} are used to perform the forward-projection step 101a, 101b. In this step, samples from reference views are projected into a synthesized view using the DIBR algorithm. The outputs of this step are: s_{T,l}′, s_{T,r}′, s_{D,l}′ and s_{D,r}′ pictures and left and right texture and depths projected into the synthesized view. At the same time, the algorithm detects disoccluded areas in the output s_{T,l}′, s_{T,r}′, s_{D,l}′ and s_{D,r}′ pictures. These areas are represented in form of filling masks: s_{F,l}′ and s_{F,r}′, identifying areas of synthesized pictures from each reference view that need to be filled. The further step is a reliability map creation 105a, 105b in which s_{F,l}′ and s_{F,r}′ filling masks are modified to produce s_{R,l}′ and s_{R,r}′ reliability maps. Each reliability map specifies the contribution of every sample in the picture synthesized from the reference picture to the final value of the sample in the output picture based on an estimated probability that the value of the sample is correct. As a consequence, the values of the reliability maps can be manipulated to reduce synthesis artifacts, e.g., at the borders of the disoccluded area. In the prior art, reliability maps are adopted to reduce synthesis artifacts that result from inconsistency of texture and depth borders in a single reference view. The solution is applied to background areas neighboring the disoccluded area of the visual scene. The procedure was proposed in [“Description of 3D Video Technology Proposal by Fraunhofer HHI (HEVC compatible; configuration A)”, MPEG m22570, November 2011] and can be described as follows. For each background pixel neighboring with the disoccluded area border within a pre-defined interval, called a transition region 201, the reliability of the pixel 200 decreases according to a linear function 203 as can be seen in FIG. 2. As a result, the reliability of pixels positioned directly at the disoccluded area border is equal to 0 and increases linearly in a horizontal direction to a maximum reliability for pixels which distance from the border is equal to the width of the transition region ΔTR 201.

Before the final step of combining 107 the synthesized pictures from left and right reference pictures, a plane discrimination map between left and right view s_{P,lr}′ is calculated 103, based on pre-defined criteria. For the purpose of the combination step 107, a sample from each of the reference views is compared with its corresponding sample from the other available reference view in order to determine if it belongs to the same plane of the visual scene or not. If a sample at the pixel position (x,y) synthesized from one reference view is much closer to the camera than the one in the same pixel position but synthesized from the other reference view, both samples are marked to belong to different planes of the visual scene. The decision if one sample is much closer to the camera than the other is made by comparing the difference between depth values assigned to both samples with a pre-defined threshold. The combination step 107 uses weighted averaging with reliability maps as weights for each combined sample to calculate the value of the synthesized output sample:

v(x,y)=wₗ(x,y)vₗ(x,y)−wᵣ(x,y)vᵣ(x,y)

where:

v(x,y) denotes the value of sample in the synthesized picture at position (x,y),

vₗ(x,y) denotes the value of sample in picture synthesized from left reference picture at position (x,y),

vᵣ(x,y) denotes the value of sample in picture synthesized from right reference picture at position (x,y),

wₗ(x,y) denotes the weight of vₗ(x,y) sample,

wᵣ(x,y) denotes the weight of vᵣ(x,y) sample.

However, in case of two samples belonging to different planes of the visual scene, the value of the output sample is calculated based on the value of only one of the input samples, that is, the one that is closer to the camera. The decision is made based on the plane discrimination map s_{P,lr}′ and the depth maps s_{D,l}′ and s_{D,r}′.

In DIBR methods used for virtual view synthesis inter-view inconsistency between depth maps of the different reference views may cause scene objects synthesis artifacts in form of an additional object border, if more than one reference view is used in the combination step to produce the synthesized output picture. An overcome to this problem is to use inter-view consistent depth maps. However, in existing multi-camera scenarios, the estimation or acquisition of inter-view consistent depth maps is very difficult or even practically unachievable with current technologies. The main problems are the large computational complexity, extreme difficulties to be achieved in a fully-automatic way due to errors in disparity estimation between two views. Semi-automatic or manual methods can solve the problem, but they are not always applicable.

### SUMMARY

It is the object of the invention to provide an improved technique for 3D view synthesis.

This object is achieved by the features of the independent claims. Further implementation forms are apparent from the dependent claims, the description and the figures.

The invention is based on the finding that an improved technique for 3D view synthesis that minimizes the synthesis artifacts for objects in the scene produced by weighted averaging of pictures synthesized from reference pictures can be provided by weighted averaging of pictures synthesized from reference pictures by reducing the weights for samples neighboring to the object borders in case the object borders in reference pictures are not aligned. Further improvement can be provided by appropriate specification of the conditions for applying the weights reduction and pattern to modify the weights.

In order to describe the invention in detail, the following terms, abbreviations and notations will be used.
3D: three-dimensional,
3D video: signal comprising two texture views and their corresponding depth or disparity maps,
visual scene: real world or synthetic scene that is represented in the 3D video,
depth map: a gray scale picture in which value of every point of the picture determines distance to the camera of the visual scene represented by this point. Alternatively, a disparity map may be used, which values are inversely proportional to the ones of the depth map and, thus, forms a depth map according to the present invention with inversed values,
disoccluded area: area of the picture synthesized from a reference view that is not visible in this reference view,
visual plane: area of the picture that refers to part of the visual scene with similar distance to the camera; a pixel is assigned to a particular visual plane based on the semantic analysis of the content represented in the visual scene or depth values assigned to each part of the picture,
foreground object: an object in visual scene with smaller distance to the camera than the area of the scene that is neighboring the border of this object and does not belong to the same visual plane as this neighboring area,
foreground and background areas neighboring the disoccluded area of the visual scene: in case of horizontal camera arrangement, picture areas neighboring left and right borders of the disoccluded area belong to visual planes with different distance to the camera. In that sense, background area is defined as the picture area that belongs to visual plane with larger distance to the camera, whereas foreground area is defined as the picture area that belongs to visual plane with smaller distance to the camera,
virtual view (herein also referred to as synthesized view):
   a view of the visual scene generated in the freely selected position that is not restricted to the actual position of the cameras used to acquire the visual scene,
synthesized picture: one frame of the virtual view,
reference picture: one frame of the reference view.

According to a first aspect, the invention relates to a method for computing a synthesized picture of a visual scene, based on a left depth map of a left reference view of the visual scene and a right depth map of a right reference view of the visual scene, the method comprising projecting the left depth map into a left projected depth map and projecting the right depth map into a right projected depth map, and determining a left disoccluded area in the left projected depth map and a right disoccluded area in the right projected depth map; detecting object border misalignments between the left projected depth map and the right projected depth map; determining a left reliability map information based on the left disoccluded area, and the detected object border misalignments, and determining a right reliability map information based on the right disoccluded area, and the detected object border misalignments; and computing the synthesized picture by merging a left projected picture of the left reference view and a right projected picture of the right reference view using the left and right reliability map information.

By detecting object border misalignments between the left projected depth map and the right projected depth map and determining the left reliability map information based on the left disoccluded area and the detected object border misalignments, and determining the right reliability map information based on the right disoccluded area and the detected object border misalignments, the view synthesis errors resulting from inaccurate depth or disparity estimation between the two views can be reduced.

In a first possible implementation form of the method according to the first aspect, determining the left reliability map information and the right reliability map information comprises determining the left reliability map information based on the left disoccluded area and the right reliability map information based on the right disoccluded area; and modifying the left reliability information and/or the right reliability map information when object border misalignments between the left projected depth map and the right projected depth map are detected.

By modifying the left reliability information and/or the right reliability map information in case of object border misalignment detection, quality of the synthesized picture can be improved.

In a second possible implementation form of the method according to the first implementation form of the first aspect, determining a plane discrimination map between the left projected depth map s_{D,r}′ and the right projected depth map based on the left projected depth map and the right projected depth map; determining a left plane discrimination map for the left projected depth map based on the left projected depth map; and determining a right plane discrimination map for the right projected depth map based on the right projected depth map; wherein determining the left reliability map information is based on the left plane discrimination map and on the plane discrimination map, and determining the right reliability map information is based on the right plane discrimination map and on the plane discrimination map.

By determining the left and the right reliability maps based on the plane discrimination maps, view synthesis errors resulting from inaccurate depth or disparity maps can be reduced.

In a third possible implementation form of the method according to the first aspect as such or according to any of the preceding implementation forms of the first aspect, detecting object border misalignments comprises detecting whether samples in one of the left projected depth map and right projected depth map belong to an object border and at the same positions belong to a foreground plane in the other projected depth map.

By detecting the object border misalignment, visible and annoying view synthesis artifacts resulting from inaccurate and inter-view consistent depth or disparity maps can be significantly reduced.

In a fourth possible implementation form of the method according to first aspect as such or any of the implementation forms of the first aspect, the object border misalignment is detected if samples in a first of the left projected depth map and right projected depth map belong to an object border and at the same positions belong to a foreground plane in the other second projected depth map of the left projected depth map and right projected depth map; wherein determining the left reliability map information comprises assigning a reduced weight for samples in the left projected picture for the computing of the synthesized picture if the samples in the left projected depth map belong to an object border and at the same positions belong to a foreground plane in the right projected depth map; and/or wherein determining the right reliability map information comprises assigning a reduced weight for samples in the right projected picture for the computing of the synthesized picture if the samples in the right projected depth map belong to an object border and at the same positions belong to a foreground plane in the left projected depth map.

By reducing the weights of the one of the left and right reliability maps corresponding to the one of the left and right projected pictures in which the influence is suppressed, synthesis artifacts can be reduced.

In a fifth possible implementation form of the method according to the fourth implementation form of the first aspect, the reduced weights are assigned according to a monotonically increasing or decreasing function over a transition region determined based on the positions of the samples belonging to the object border.

Reducing the weights according to a monotonically increasing or decreasing function is easy to implement, e.g., by a lookup table.

In a sixth possible implementation form of the method according to the first aspect as such or according to any of the preceding implementation forms of the first aspect, determining the left reliability map information comprises assigning a reduced weight for samples in the left projected picture for the computing of the synthesized picture, if a first sample in the left projected depth map at a first position does not belong to the left disoccluded area, a second right neighboring sample to the first sample in the left projected depth map belongs to the left disoccluded area, the first sample in the left projected depth map and a first sample in the right projected depth map at the first position belong to a same plane of the visual scene, and the first sample in the right projected depth map and a second right neighboring sample to the first sample in the right projected depth map belong to the same plane of the visual scene.

Reducing the weights of the left reliability map information in such a way can be easily implemented using logical operations. No complex computational processing is required.

In a seventh possible implementation form of the method according to the first aspect as such or according to any of the preceding implementation forms of the first aspect, assigning a reduced weight for samples in the left projected picture for the computing of the synthesized picture, if a first sample in the left projected depth map at a first position and a second left neighboring sample to the first left sample in the left projected depth map do not belong to a same plane of the visual scene, a point in the visual scene corresponding to the first sample in the left projected depth map is closer to a camera than a point in the visual scene corresponding to the second left neighboring sample in the left projected depth map, the first sample in the left projected depth map and a first sample in the right projected depth map at the first position belong to a same plane of the visual scene, and the first sample in the right projected depth map and a second left neighboring sample to the first sample in the right projected depth map belong to the same plane of the visual scene.

Reducing the weights of the left reliability map information in such a way can be easily implemented using logical operations. No complex computational processing is required.

In an eighth possible implementation form of the method according to the first aspect as such or according to any of the preceding implementation forms of the first aspect, object border misalignments are detected, and determining the right reliability map information comprises assigning a reduced weight for samples in the right projected picture for the computing of the synthesized picture, if a first sample in the right projected depth map at a first horizontal and a first vertical position does not belong to the right disoccluded area, a second left neighboring sample to the first sample in the right projected depth map belongs to the right disoccluded area, the first sample in the right projected depth map and a first sample in the left projected depth map at the first horizontal and the first vertical position belong to a same plane of the visual scene, and the first sample in the left projected depth map and a second left neighboring sample to the first sample in the left projected depth map belong to the same plane of the visual scene.

Reducing the weights of the right reliability map information in such a way can be easily implemented using logical operations. No complex computational processing is required.

In a ninth possible implementation form of the method according to the first aspect as such or according to any of the preceding implementation forms of the first aspect, determining the right reliability map information comprises assigning a reduced weight for samples in the right projected picture for the computing of the synthesized picture, if a first right sample in the right projected depth map at a first horizontal and a first vertical position and a second right neighboring sample to the first sample, in the right projected depth map do not belong to a same plane of the visual scene, a point in the visual scene corresponding to the first sample in the right projected depth map is closer to a camera than a point in the visual scene corresponding to the second right neighboring sample in the right projected depth map, the first sample in the right projected depth map and a first sample in the left projected depth map at the first horizontal and the first vertical position belong to a same plane of the visual scene, and the first sample in the left projected depth map and a second right neighboring sample to the first sample in the left projected depth map belong to the same plane of the visual scene.

Reducing the weights of the right reliability map information in such a way can be easily implemented using logical operations. No complex computational processing is required.

In a tenth possible implementation form of the method according to the first aspect as such or according to any of the preceding implementation forms of the first aspect, the merging the left and right projected pictures comprises weighting a sample in the left projected picture by the weight of the left reliability map and weighting a sample in the right projected picture by the weight of the right reliability map.

When the merging the left and right projected pictures is applied on the modified weights, object synthesis artifacts can be reduced.

In an eleventh possible implementation form of the method according to the tenth implementation form of the first aspect, the method comprises combining the weighted sample in the left projected picture and the weighted sample in the right projected picture to obtain a sample in the synthesized picture.

Combining the weighted samples can be easily performed, e.g., by using a simple addition operation.

In a twelfth possible implementation form of the method according to the eleventh implementation form of the first aspect, in case of a sample in the left projected picture and a sample in the right projected picture belong to different planes of visual scene, the sample in the synthesized picture is calculated based on only the one of the sample in the left projected picture and the sample in the right projected picture, which belongs to the closer plane.

By calculating the sample in the synthesized picture based on only one of the sample in the left projected picture and the sample in the right projected picture, the influence of the errors in the depth or disparity estimation to the view synthesis can be reduced. By using the sample which is located closer to a camera position, the reliability of the sample in the synthesized picture is increased.

In a thirteenth possible implementation form of the method according to the first aspect as such or any of the implementation forms of the first aspect, the left and right projected pictures are projected texture pictures, the left and right projected pictures are the projected depth map pictures), or the left and right projected pictures are projected disparity pictures.

In a fourteenth possible implementation form of the method according to the first aspect as such or any of the implementation forms of the first aspect, the left depth map of the left reference view of the visual scene is a left disparity map of the left reference view of the visual scene, and the right depth map of the right reference view of the visual scene is a right disparity map of the right view of the visual scene; and wherein the left projected depth map is a left projected disparity map and the right projected depth map is a right projected disparity map.

According to a second aspect, the invention relates to computer program for performing the method of the first aspect as such or any of the implementation forms according to the first aspect, when executed on a processor or computer.

According to a third aspect, the invention relates to computer program product comprising a computer readable storage medium storing program code thereon for use by a programmable processor or computer system, the program code comprising instructions for executing a method according to the first aspect as such or any of the implementation forms of the first aspect.

The computer program or program code can be provided in form of a source code or machine-readable code, e.g., as firmware, software or any combination thereof.

The computer program can be provided on a digital storage medium, for example a hard disc, compact disc (CD), digital versatile disc or digital video disc (DVD) or Blu-ray disc, having an electronically readable control signal stored thereon, which co-operates with the programmable processor or programmable computer system such that a method according to the first aspect as such or any of its implementation forms is performed, Alternatively the computer program or program code can be provided by downloading via a network.

According to a fourth aspect, an apparatus comprising a processor configured to perform the method according to the first aspect as such or any of the implementation forms of the first aspect is provided.

The methods, systems and devices described herein may be implemented as software in a Digital Signal Processor (DSP), in a micro-controller or in any other side-processor or as hardware circuit within an application specific integrated circuit (ASIC).

The invention can be implemented in digital electronic circuitry, or in computer hardware, firmware, software, or in combinations thereof, e.g., in available hardware of conventional mobile devices or in new hardware dedicated for processing the methods described herein.

### BRIEF DESCRIPTION OF THE FIGURES

Further embodiments of the invention will be described with respect to the following figures, in which:

FIG. 1 shows a block diagram illustrating a conventional synthesis algorithm 100 for 3D view synthesis;

FIG. 2 shows a diagram 200 illustrating a reliability of pixels in the synthesis algorithm depicted in FIG. 1;

FIG. 3 shows a schematic diagram illustrating a method 300 for computing a synthesized picture of a visual scene according to an implementation form;

FIG. 4 shows a schematic diagram 400 illustrating synthesizing of an exemplary 3D scene to a synthesized view according to an implementation form;

FIG. 5 shows a schematic diagram illustrating conditions 500 for modification of the reliability map according to an implementation form;

FIG. 6 shows a diagram 600 illustrating exemplary patterns for reducing or modifying the values of a reliability map according to an implementation form;

FIG. 7 shows a block diagram of an apparatus 700 for computing a synthesized picture of a visual scene according to an implementation form; and

FIG. 8 shows a block diagram illustrating a reliability map creation block 705 in an apparatus 700 for computing a synthesized picture of a visual scene according to an implementation form.

Equal or equivalent elements are denoted in the following description of the figures by equal or equivalent reference signs.

### DETAILED DESCRIPTION OF EMBODIMENTS OF THE INVENTION

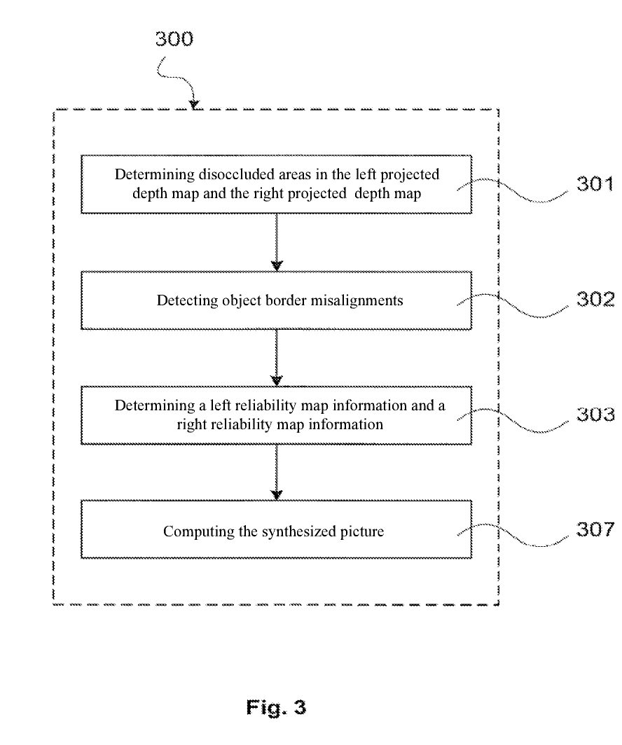

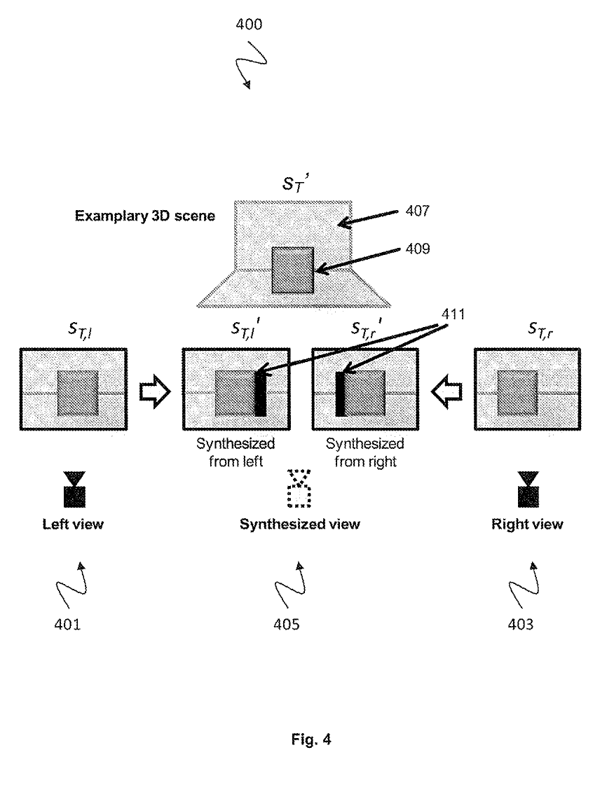

FIG. 3 shows a schematic diagram illustrating a method 300 for computing a synthesized picture of a visual scene according to an implementation form. For an easier understanding, the method 300 is described with reference to FIGS. 4, 7 and 8, although implementation forms of the method or apparatus, are not limited to such implementations, for example can also be adapted to compute synthesized depth maps or synthesized disparity maps, which both form a kind of grayscale pictures, instead of synthesized texture pictures as depicted in FIGS. 4, 7 and 8.

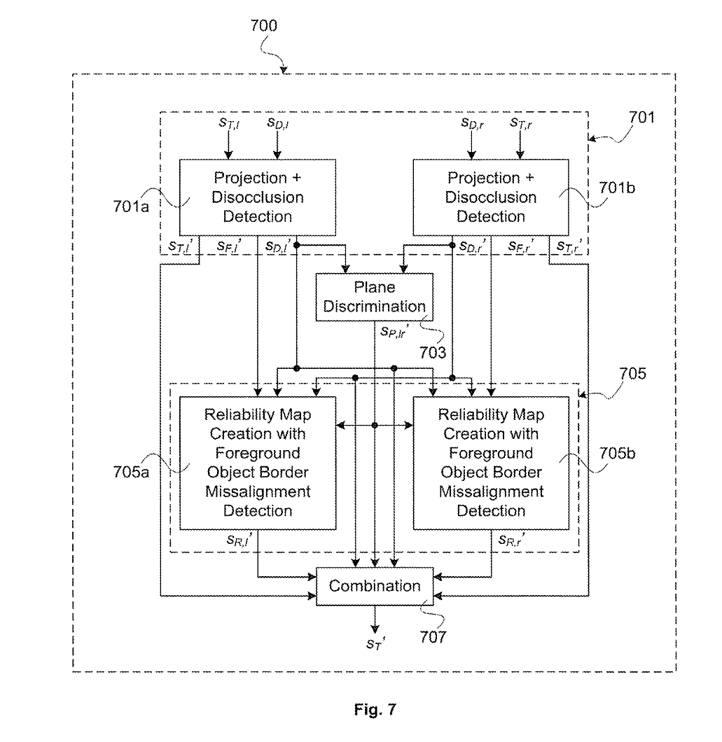

The method 300 computes a synthesized picture, for example a synthesized texture picture s_{T}′ as shown in FIGS. 4 and 7, of a visual scene, based on a left depth map s_{D,l} of a left reference view of the visual scene and a right depth map s_{D,r} of a right reference view of the visual scene. The method 300 comprises the following.

Projecting 301 the left depth map sD,l into a left projected depth map sD,l′ and projecting the right depth map sD,r into a right projected depth map sD,r′, and determining a left disoccluded area sF,l′ in the left projected depth map sD,l′ and a right disoccluded area sF,r′ in the right projected depth map sD,r′.

Detecting 302 object border misalignments between the left projected depth map sD,l′ and the right projected depth map sD,r′.

Determining 303 a left reliability map information sR,l′ based on the left disoccluded area sF,l′, and the detected object border misalignments, and determining a right reliability map information sR,r′ based on the right disoccluded area sF,r′, and the detected object border misalignments.

Computing 307 the synthesized picture sT′ by merging a left projected picture sT,l′ of the left reference view and a right projected picture sTr′ of the right reference view using the left sR,l′ and right sR,r′ reliability map information.

In an implementation, determining 303 the left reliability map information s_{R,l}′ and the right reliability map information s_{R,r}′ comprises the following. Determining the left reliability map information s_{R,l}′ based on the left disoccluded area s_{F,l}′ and the right reliability map information s_{R,r}′ based on the right disoccluded area s_{F,r}′. Modifying the left reliability map information s_{R,l}′ and/or the right reliability map information s_{R,r}′ when object border misalignments between the left projected depth map and the right projected depth map are detected.

In an implementation, the method 300 further comprises the following. Determining a plane discrimination map s_{P,lr}′ between the left projected depth map s_{D,r}′ and the right projected depth map s_{D,r}′ based on the left projected depth map s_{D,l}′ and the right projected depth map s_{D,r}′. Determining a left plane discrimination map s_{P,ll}′ for the left projected depth map s_{D,l}′based on the left projected depth map s_{D,l}′. Determining a right plane discrimination map s_{P,rr}′ for the right projected depth map s_{D,r}′ based on the right projected depth map s_{D,r}′, wherein determining 303 the left reliability map information s_{R,l}′ is based on the left plane discrimination map s_{P,ll}′ and on the plane discrimination map s_{P,lr}′, and determining the right reliability map information s_{R,r}′ is based on the right plane discrimination map s_{P,rr}′ and on the plane discrimination map s_{P,lr}′.

In an implementation, detecting 302 object border misalignments comprises detecting whether samples in one of the left projected depth map s_{D,l}′ and right projected depth map s_{D,r}′ belong to an object border and at the same positions (x,y) belong to a foreground plane in the other projected depth map.

In an implementation, an object border misalignment is detected if samples in a first of the left projected depth map s_{D,l}′ and right projected depth map s_{D,r}′ belong to an object border and at the same positions (x,y) belong to a foreground plane in the other second projected depth map of the left projected depth map s_{D,l}′ and right projected depth map s_{D,r}′; wherein determining 303 the left reliability map information s_{R,l}′ comprises assigning a reduced weight for samples in the left projected picture s_{T,l}′ for the computing of the synthesized picture s_{T}′ if the samples in the left projected depth map s_{D,l}′ belong to an object border and at the same positions (x,y) belong to a foreground plane in the right projected depth map s_{D,r}′; and/or wherein determining 303 the right reliability map information s_{R,r}′ comprises assigning a reduced weight for samples in the right projected picture s_{T,r}′ for the computing of the synthesized picture s_{T}′ if the samples in the right projected depth map s_{D,r}′ belong to an object border and at the same positions (x,y) belong to a foreground plane in the left projected depth map s_{D,l}′.

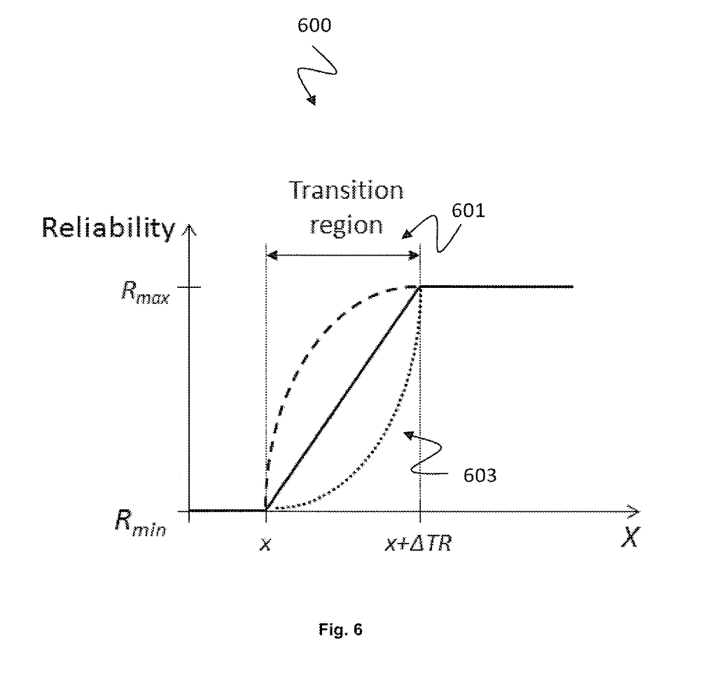

In an implementation, the reduced weights are assigned according to a monotonically increasing or decreasing function (603) over a transition region (601) determined based on the positions of the samples belonging to the object border as described below with respect to FIG. 6.

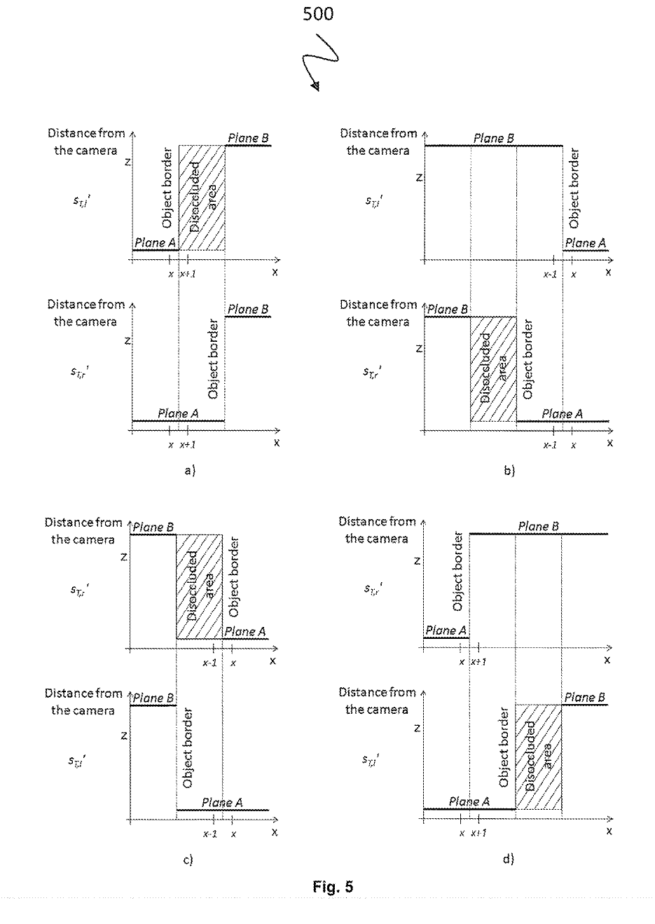

In an implementation as described below with respect to FIG. 5A, determining 303 the left reliability map information s_{R,l}′ comprises assigning a reduced weight for samples in the left projected picture s_{T,l}′ for the computing of the synthesized picture s_{T}′, if a first sample vₗ(x,y) in the left projected depth map s_{D,l}′ at a first position (x,y) does not belong to the left disoccluded area s_{F,l}′, a second right neighboring sample vₗ(x+1,y) to the first sample vₗ(x,y) in the left projected depth map s_{D,l}′ belongs to the left disoccluded area s_{F,l}′, the first sample vₗ(x,y) in the left projected depth map s_{D,l}′ and a first sample vᵣ(x,y) in the right projected depth map s_{D,r}′ at the first position (x,y) belong to a same plane of the visual scene, and the first sample vᵣ(x,y) in the right projected depth map s_{D,r}′ and a second right neighboring sample vᵣ(x+1,y) to the first sample vᵣ(x,y) in the right projected depth map s_{D,r}′ belong to the same plane of the visual scene.

In an implementation as described below with respect to FIG. 5B, object border misalignments are detected and determining 303 the left reliability map information s_{R,l}′ comprises assigning a reduced weight for samples in the left projected picture s_{T,l}′ for the computing of the synthesized picture s_{T}′, if a first sample vₗ(x,y) in the left projected depth map s_{D,l}′ at a first position (x,y) and a second left neighboring sample vₗ(x−1,y) to the first left sample vₗ(x,y) in the left projected depth map do not belong to a same plane of the visual scene, a point in the visual scene corresponding to the first sample vₗ(x,y) in the left projected depth map is closer to a camera than a point in the visual scene corresponding to the second left neighboring sample vₗ(x−1,y) in the left projected depth map, the first sample vₗ(x,y) in the left projected depth map s_{D,l}′ and a first sample vᵣ(x,y) in the right projected depth map s_{D,r}′ at the first position (x,y) belong to a same plane of the visual scene, and the first sample vᵣ(x,y) in the right projected depth map s_{D,r}′ and a second left neighboring sample vᵣ(x−1,y) to the first sample vᵣ(x,y) in the right projected depth map s_{D,r}′ belong to the same plane of the visual scene.

In an implementation as described below with respect to FIG. 5C, object border misalignments are detected, and determining 303 the right reliability map information s_{R,r}′ comprises assigning a reduced weight for samples in the right projected picture s_{T,r}′ for the computing of the synthesized picture s_{T}′, if a first sample vᵣ(x,y) in the right projected depth map s_{D,r}′ at a first horizontal x and a first vertical y position does not belong to the right disoccluded area s_{F,r}′, a second left neighboring sample vᵣ(x−1,y) to the first sample vᵣ(x,y) in the right projected depth map s_{D,r}′ belongs to the right disoccluded area s_{F,r}′, the first sample vᵣ(x,y) in the right projected depth map s_{D,l}′ and a first sample vₗ(x,y) in the left projected depth map s_{D,l}′ at the first horizontal x and the first vertical y position belong to a same plane of the visual scene, and the first sample vₗ(x,y) in the left projected depth map s_{D,l}′ and a second left neighboring sample vₗ(x−1,y) to the first sample vₗ(x,y) in the left projected depth map s_{D,l}′ belong to the same plane of the visual scene.

In an implementation as described below with respect to FIG. 5D, object border misalignments are detected and determining 303 the right reliability map information s_{R,r}′ comprises assigning a reduced weight for samples in the right projected picture s_{T,r}′ for the computing of the synthesized picture s_{T}′, if a first right sample vᵣ(x,y) in the right projected depth map s_{D,r}′ at a first horizontal x and a first vertical y position and a second right neighboring sample vᵣ(x+1,y) to the first sample vᵣ(x,y) in the right projected depth map s_{D,r}′ do not belong to a same plane of the visual scene, a point in the visual scene corresponding to the first sample vᵣ(x,y) in the right projected depth map s_{D,r}′ is closer to a camera than a point in the visual scene corresponding to the second right neighboring sample vᵣ(x+1,y) in the right projected depth map s_{D,r}′, the first sample vᵣ(x,y) in the right projected depth map s_{D,r}′ and a first sample vₗ(x,y) in the left projected depth map s_{D,l}′ at the first horizontal x and the first vertical y position belong to a same plane of the visual scene, and the first sample vₗ(x,y) in the left projected depth map s_{D,l}′ and a second right neighboring sample vₗ(x+1,y) to the first sample vₗ(x,y) in the left projected depth map s_{D,l}′ belong to the same plane of the visual scene.

In an implementation, merging the left s_{T,l}′ and right s_{T,r}′ projected pictures comprises weighting a sample vₗ(x,y) in the left projected picture s_{T,l}′ by the weight of the left reliability map s_{R,l}′ and weighting a sample vᵣ(x,y) in the right projected picture s_{T,r}′ by the weight of the right reliability map s_{R,r}′.

In an implementation, the method 300 comprises combining the weighted sample vₗ(x,y) in the left projected picture s_{T,l}′ and the weighted sample vᵣ(x,y) in the right projected picture s_{T,r}′ to obtain a sample v(x,y) in the synthesized picture.

In an implementation, in case a sample vₗ(x,y) in the left projected picture s_{T,l}′ and a sample vᵣ(x,y) in the right projected picture s_{T,r}′ belong to different planes of the visual scene, the sample v(x,y) in the synthesized picture is calculated based only on the sample vₗ(x,y) in the left projected picture s_{T,l}′ or the sample vᵣ(x,y) in the right projected picture s_{T,r}′, which belongs to the closer plane.

In an implementation, the sample v(x,y) in the synthesized picture is calculated based on the one of the sample vₗ(x,y) in the left projected picture s_{T,l}′ and the sample vᵣ(x,y) in the right projected picture s_{T,r}′ which sample is closer to a camera.

Implementation forms may be adapted to compute a synthesized texture picture s_{T}′, as synthesized picture, as for example depicted in FIGS. 4, 5, 7 and 8, or may be adapted to compute a synthesized depth map picture s_{D}′ or both. Further implementation forms may be adapted to compute a synthesized disparity map picture for the synthesized view 405 instead of a synthesized depth map picture. Accordingly, in further implementation forms of the method 300, the left and right projected pictures are projected texture pictures (s_{T,l}′, s_{T,r}′), the left and right projected pictures are the projected depth map pictures (s_{D,l}′, s_{D,r}′), or the left and right projected pictures are projected disparity pictures.

In further implementation forms of the method 300, disparity maps, which are depth maps with inverse values, are used instead of the depth maps as such. Accordingly, the left depth map s_{D,l} of the left reference view of the visual scene is a left disparity map s_{D,l} of the left reference view of the visual scene, and the right depth map s_{D,r} of the right reference view of the visual scene is a right disparity map of the right view of the visual scene; and wherein the left projected depth map s_{D,l}′ is a left projected disparity map and the right projected depth map s_{D,r}′ is a right projected disparity map.

FIG. 4 shows a schematic diagram 400 illustrating synthesizing of an exemplary 3D scene to a synthesized view 405 according to an implementation form. The exemplary 3D scene comprises a foreground object 409 and a background 407.

Inter-view inconsistency between depth maps of the different reference views 401, 403 may cause a misalignment between object borders in pictures synthesized or projected from left and right reference pictures: s_{T,l}′ and s_{T,r}′. s_{T,l}′ is also referred to as left projected picture of the left reference view, and s_{T,r}′ is also referred to as right projected picture of the right reference view. As s_{T,l}′ and s_{T,r}′ pictures are further used in the combination step 307 of the method 300 for computing the synthesized picture 405 as described above with respect to FIG. 3, this misalignment may result in producing an additional border 411 for the object 409 in the synthesized output picture 405 combined from these two reference views 401, 403.

In order to minimize this effect, the method 300 applies border misalignment detection for objects in the analyzed visual scene and suppresses the influence of samples in one of the s_{T,l}′ or s_{T,r}′ pictures in which the border 411 of the object corresponds to the area marked as foreground in the other picture. Samples from such a picture are assigned a smaller reliability in order to minimize their impact during the weighted averaging in the combination step for obtaining the synthesized output picture 405.

FIG. 5 shows a schematic diagram illustrating conditions 500 for modification of the reliability map according to an implementation form. FIGS. 5A and 5B describe a first and second case for the left s_{R,l}′ reliability map and FIGS. 5C and 5D describe a first and second case for the right s_{R,r}′ reliability map.

The following notation is applied: vₗ(x,y) denotes a sample in the picture synthesized from the left reference picture s_{T,l}′ at position (x,y). vᵣ(x,y) denotes a sample in the picture synthesized from the right reference picture s_{T,r}′ at position (x,y).

In an implementation form, the conditions to determine if the modification of the reliability map s_{R,l}′ or s_{R,r}′ at position (x,y) is being applied are as follows:

For the left reliability map s_{R,l}′ as depicted in FIGS. 5A and 5B, the following two cases (Case 1 and Case 2) apply.

Case 1: (modification or assignment of a reduced value is applied only if all of the conditions are fulfilled), see FIG. 5A.

a. Sample vₗ(x,y) does not belong to disoccluded area.
b. Right neighboring sample vₗ(x+1,y) belongs to disoccluded area.
c. Samples vₗ(x,y) and vᵣ(x,y) belong to the same plane of the visual scene.
d. Samples vᵣ(x,y) and vᵣ(x+1,y) belong to the same plane of the visual scene.
Case 2: (modification or assignment of a reduced value is applied only if all of the conditions are fulfilled), see FIG. 5B.
a. Left neighboring sample vₗ(x−1,y) does not belong to the same plane of the visual scene as the sample vₗ(x,y).
b. The point in the visual scene correspondent to the sample vₗ(x,y) is closer to the camera than the one represented by the left neighboring sample vₗ(x−1,y).
c. Samples vₗ(x,y) and vᵣ(x,y) belong to the same plane of the visual scene.
d. Samples vᵣ(x−1,y) and vᵣ(x,y) belong to the same plane of the visual scene.

For the right reliability map as depicted in FIGS. 5C and 5D, the following two cases (Case 1 and Case 2) apply.

Case 1: (modification or assignment of a reduced value is applied only if all of the conditions are fulfilled), see FIG. 5C.
a. Sample vᵣ(x,y) does not belong to disoccluded area.
b. Left neighboring sample vᵣ(x−1,y) belongs to disoccluded area.
c. Samples vᵣ(x,y) and vₗ(x,y) belong to the same plane of the visual scene.
d. Samples vₗ(x−1,y) and vₗ(x,y) belong to the same plane of the visual scene.
Case 2: (modification or assignment of a reduced value is applied only if all of the conditions are fulfilled), see FIG. 5D.
a. Right neighboring sample vᵣ(x−1,y) does not belong to the same plane of the visual scene as the sample vᵣ(x,y).
b. The point in the visual scene correspondent o the sample vᵣ(x,y) is closer to the camera than the one represented by the right neighboring sample vᵣ(x−1,y).
c. Samples vᵣ(x,y) and vₗ(x,y) belong to the same plane of the visual scene.
d. Samples vₗ(x,y) and vₗ(x−1,y) belong to the same plane of the visual scene.

Information if the sample belongs to the disoccluded area or not is determined in the projection step 301 in which samples from the reference picture are projected into the synthesized picture. Such information, e.g., left and right disoccluded areas s_{F,l}′ and s_{F,r}′ are usually represented in form of binary masks, e.g., in left and right filling masks s_{F,l}′ and s_{F,r}′ according to the HEVC Test Model as described above.

The decision if the two samples belong to the same plane of the visual scene is made based on plane discrimination criteria. For that purpose, in an implementation form, plane discrimination criteria introduced in the prior art are used. Consequently, in case of the samples located at the same position (x,y) but belonging to different views, i.e., vₗ(x,y) and vᵣ(x,y), the decision can be made based on the plane discrimination map s_{P,lr}′ calculated already in the plane discrimination step according to the prior art synthesis algorithm. On the other hand, for neighboring samples from the same view, e.g., vₗ(x,y) and vₗ(x−1,y), the same plane discrimination criteria is used, however, the input of the decision function is only one depth map of the analyzed view (s_{D,l}′ or s_{D,r}′) and, consequently, a plane discrimination map is computed independently for each view, producing plane discrimination maps for left and right view: s_{P,ll}′ and s_{P,rr}′, also referred to as left and right plane discrimination maps s_{P,ll}′ and s_{P,rr}′.

Also, a distance of the point in the visual scene correspondent to each sample is determined based on the corresponding depth map, and the left projected depth map s_{D,l}′ is used for the modification or assignment of reduced values of the left reliability map s_{R,l}′, and the right projected depth map s_{D,r}′ is used for the modification or assignment of reduced values of the right reliability map s_{R,r}′. In an alternative implementation form, in any case of utilization of depth maps, disparity maps are used for the same purpose.

The modification or assignment of reduced values of the reliability map s_{R,l}′ or s_{R,r}′ according to the specified pattern is applied to all neighboring samples within the defined transition region ΔTR 601 if the appropriate above described conditions for sample at position (x,y) are fulfilled.

A. For the s_{R,l}′ reliability map:
Case 1: samples within range [x−ΔTR,x] are modified: Rₘᵢₙ reliability is assigned to s_{R,l}′ at position (x,y) and Rₘₐₓ reliability is assigned to s_{R,l}′ at position (x−ΔTR,y).
Case 2: samples within range [x,x+ΔTR] are modified: Rₘᵢₙ reliability is assigned to s_{R,l}′ at position (x,y) and Rₘₐₓ reliability is assigned to s_{R,l}′ at position (x+ΔTR,y)
B. For the reliability map:
Case 1: samples within range [x,x+ΔTR] are modified: Rₘᵢₙ reliability is assigned to s_{R,l}′ at position (x,y) and Rₘₐₓ reliability is assigned to s_{R,l}′ at position (x+ΔTR,y).
Case 2: samples within range [x−ΔTR,x] are modified: Rₘᵢₙ reliability is assigned to s_{R,l}′ at position (x,y) and Rₘₐₓ reliability is assigned to s_{R,l}′ at position (x−ΔTR,y)
In the above description Rₘᵢₙ and Rₘₐₓ are defined accordingly: minimum and maximum reliability values that are assigned to the samples of the reliability map within the transition region 601.

FIG. 6 shows a diagram 600 illustrating exemplary patterns for modifying the values or assigning reduced values of the left and right reliability map s_{R,l}′ or s_{R,r}′ according to an implementation form.

In an implementation form, the pattern specifying the values of the reliability map s_{R,l}′ or s_{R,r}′ inside the transition region 601 is any monotonically increasing function 603, which values are:
Rₘᵢₙ assigned to the first sample in the transition region 601,
Rₘₐₓ assigned to the last sample in the transition region 601.

The first sample in the transition region 601 is the sample at position (x,y) for which the conditions for modifying the reliability map are fulfilled. The coordinates of the last sample in the transition region 601 are consequently equal to (x−ΔTR,y) or (x+ΔTR,y) depending on the case for which border misalignment was detected. ΔTR denotes the width of the transition region 601.

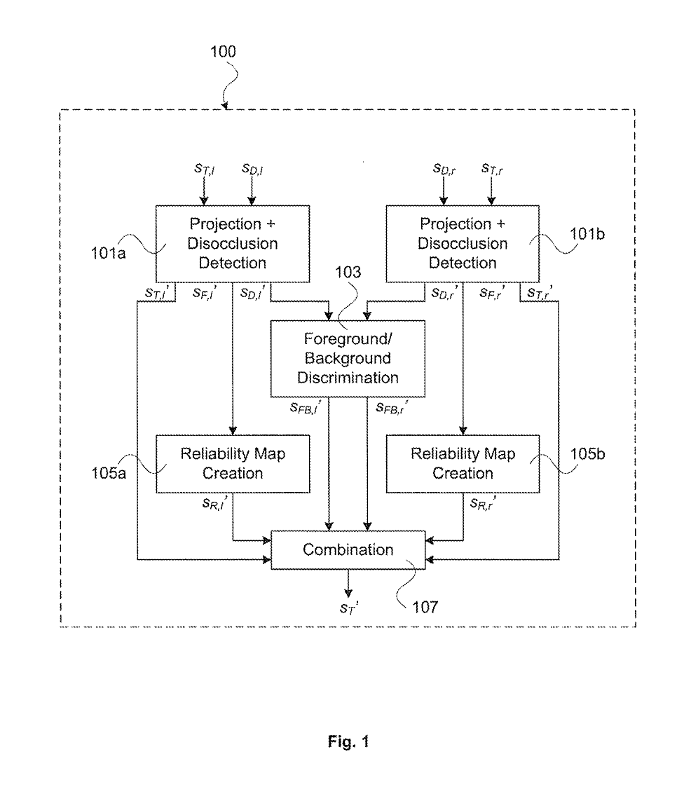

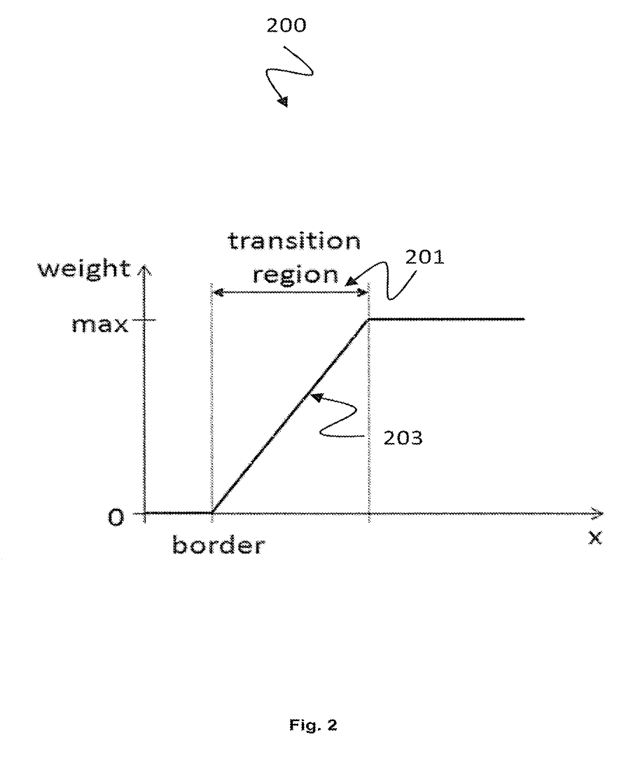

In an implementation form, other steps of view synthesis are performed as in the prior art described above with respect to FIGS. 1 and 2.

FIG. 7 shows a block diagram of an apparatus 700 for computing a synthesized picture of a visual scene according to an implementation form.

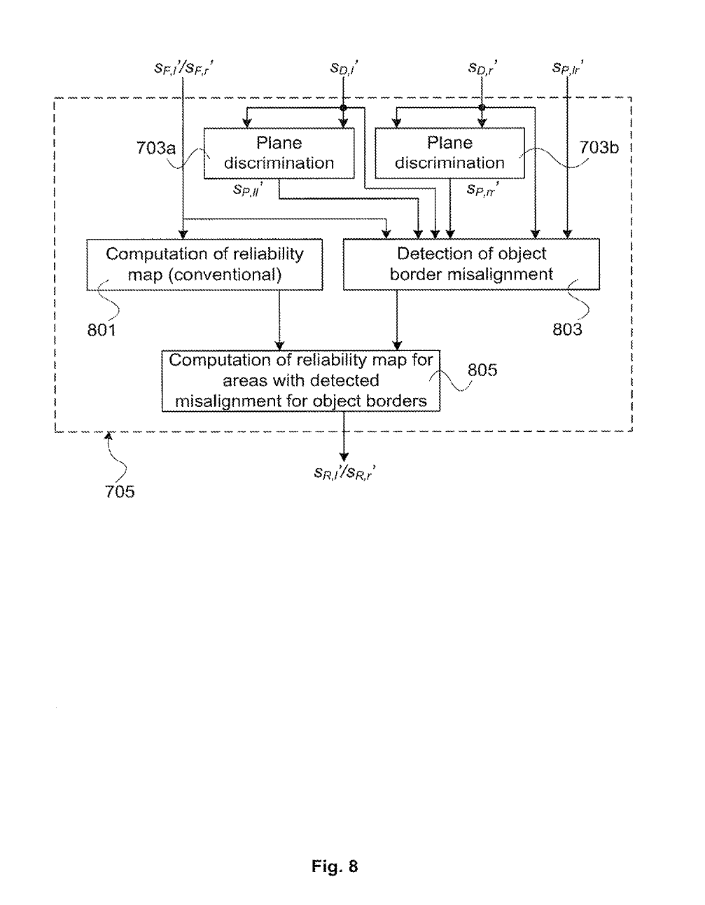

The computing the synthesized picture s_{T}′ of a visual scene is starting from left s_{T,l} and right s_{T,r} reference pictures and their corresponding left s_{D,l} and right s_{D,r} depth maps. The apparatus 700 comprises a projector 701 configured for projecting the left reference picture s_{T,l} into a left projected picture s_{T,l}′ and projecting the right reference picture s_{T,r} into a right projected picture s_{T,r}′ and determining a left disoccluded area s_{F,l}′ in the left projected picture s_{T,l}′ and a right disoccluded area s_{F,r}′ in the right s_{T,r}′ projected picture. The apparatus 700 comprises a determiner 705 configured for determining a left reliability map s_{R,l}′ based on the left disoccluded area s_{F,l}′ and a right reliability map s_{R,r}′ based on the right disoccluded area s_{F,r}′. The apparatus 700 comprises a modifier 805, see FIG. 8, configured for modifying weights of at least one of the left s_{R,l}′ and right s_{R,r}′ reliability maps when misaligned object borders are detected in at least one of the left s_{T,l}′ and right s_{T,r}′ projected pictures. The apparatus 700 comprises a processor 707 configured for computing the synthesized picture s_{T}′ by merging the left s_{T,l}′ and right s_{T,r}′ projected pictures using the left s_{R,l}′ and right s_{R,r}′ reliability maps. The projector 701 comprises a left projector 701a for projecting the left reference picture s_{T,l} and a right projector 701b for projecting the right reference picture s_{T,r}. The projector 701 is coupled to the determiner 705 which receives outputs of the projector 701. The determiner 705 is coupled to the processor 707 which receives outputs of the projector 701 and outputs of the determiner 705.

In an implementation form, the apparatus 700 comprises a plane discriminator 703 configured for receiving outputs of the projector 701 and providing outputs to the processor 707.

In an implementation form, the projector 701, the determiner 705, the processor 707 and the plane discriminator 703 are functionally specified according to the description below:

In Blocks 701a, 701b, left and right reference pictures are projected into the synthesized picture, and disoccluded areas are detected. In block 703, plane discrimination map between left and right picture is calculated. In blocks 705a, 705b, the information received from blocks 701a, 701b and block 703 is combined to build up a reliability map. In an implementation, the reliability map is built up as in the prior art as described above with respect to FIGS. 1 and 2. A misalignment between object borders in pictures synthesized from left and right reference pictures is detected. For the areas with misalignment between object borders in pictures synthesized from left and right reference pictures detected, the reliability map is modified applying the method 300 as described above. In block 707, the combination step allows to complete the view synthesis by merging pictures synthesized from left and right reference views.

The following symbols are used in FIG. 7: s_{T,l} and s_{T,r} (left and right view textures), and s_{D,l} and s_{D,r} (left and right view depth maps), s_{T,l}′, s_{T,r}′, s_{D,l}′ and s_{D,r}′ are the left and right texture and depths projected into virtual view, s_{P,rl}′ is the plane discrimination map between left and right view, s_{F,l}′ and s_{F,r}′ are filling masks (identifying disoccluded areas that need to be filled), s_{R,l}′ and s_{R,r}′ are the reliability maps for the left and right views respectively.

FIG. 8 shows a block diagram illustrating a reliability map creation block 705 in an apparatus 700 for computing a synthesized picture of a visual scene according to an implementation form. The reliability map creation block 705 may correspond to the determiner 705 as described above with respect to FIG. 7.

In an implementation form, the reliability map creation block 705 is functionally specified according to the following description: In block 801, for every sample of an input disoccluded area, e.g., input filling mask or, a reliability weight is computed according to conventional algorithms as described above with respect to the description of FIGS. 1 and 2. In blocks 703a, 703b, plane discrimination maps for the left or right view are calculated. In block 803, an object border misalignment for the left and right projected views is detected based on the disoccluded areas or filling maps of the projected views s_{F,l}′ and s_{F,r}′, the plane discrimination map s_{P,lr}′ between left and right view and the plane discrimination maps s_{P,ll}′ and s_{P,rr}′ computed independently for each view as described above. In block 805, for every sample of the reliability map created in block 801, the reliability weight is modified if an object border misalignment is detected; the weights are modified according to the monotonically decreasing pattern as described above.

Implementation forms may be adapted to first determine the left and right reliability maps or reliability map information according to conventional algorithms and afterwards to modify the left and right reliability maps or reliability map information, e.g., reduce the weights for the corresponding samples, when object border misalignments between the left and right projected depth map have been detected, as shown in FIG. 8 with regard to functional blocks 801 and 805. Alternative implementation forms may be adapted to omit the step or functional block 801 of first determining the left and right reliability maps or reliability map information according to conventional algorithms and to assign directly in step or functional block 805 reduced weights for the corresponding samples in the left and right reliability maps or reliability map information, when object border misalignments between the left and right projected depth map have been detected.

Implementation forms may be adapted to compute a synthesized texture picture s_{T}′, as synthesized picture, as for example depicted in FIGS. 4, 5, 7 and 8, or may be adapted to compute a synthesized depth map picture s_{D}′ or both. Further implementation forms may be adapted to compute a synthesized disparity map picture for the synthesized view 405 instead of a synthesized depth map picture.

In implementation forms for computing a synthesized texture picture s_{T}′, the left and right projected pictures are projected texture pictures s_{T,l}′, s_{T,r}′ obtained from left and right reference texture pictures s_{T,l}, s_{T,r} by projection.

In implementation forms for computing a synthesized depth map picture s_{D}′, the left and right projected pictures are projected depth map pictures s_{D,l}′, s_{D,r}′ obtained, for example from left and right reference depth map pictures s_{D,l}, s_{D,r} by projection, or from left and disparity map pictures by projection and inversion of the map values or vice versa.

In implementation forms for computing a synthesized disparity map picture, the left and right projected pictures are projected disparity map pictures obtained from left and right reference disparity map pictures by projection, or from left and depth map pictures by projection and inversion of the map values or vice versa.

Implementation forms may be adapted to determine the whole left and right reliability map before computing the synthesized picture or adapted, for example to determine only parts process entire pictures and corresponding maps or only those parts of left and right reliability map which are required for computing the corresponding part of the synthesized picture, i.e., implementation forms are adapted to determine left and right reliability map information.

From the foregoing, it will be apparent to those skilled in the art that a variety of methods, systems, computer programs on recording media, and the like, are provided.

The present disclosure also supports a computer program product including computer executable code or computer executable instructions that, when executed, causes at least one computer to execute the performing and computing steps described herein.

Many alternatives, modifications, and variations will be apparent to those skilled in the art in light of the above teachings. Of course, those skilled in the art readily recognize that there are numerous applications of the invention beyond those described herein. While the present inventions has been described with reference to one or more particular embodiments, those skilled in the art recognize that many changes may be made thereto without departing from the scope of the present invention. It is therefore to be understood that within the scope of the appended claims and their equivalents, the inventions may be practiced otherwise than as specifically described herein.

What is claimed is:

1. A method for computing a synthesized picture (s_{T}′) of a visual scene, based on a left depth map (s_{D,l}) of a left reference view of the visual scene and a right depth map (s_{D,r}) of a right reference view of the visual scene, the method comprising:
projecting the left depth map (s_{D,l}) into a left projected depth map (s_{D,l}′) and projecting the right depth map (s_{D,r}) into a right projected depth map (s_{D,r}′);
determining a left disoccluded area (s_{F,l}′) in the left projected depth map (s_{D,l}′) and a right disoccluded area (s_{F,r}′) in the right projected depth map (s_{D,r}′);
detecting object border misalignments between the left projected depth map (s_{D,l}′) and the right projected depth map (s_{D,r}′);
determining a left reliability map information (s_{R,l}′) based on the left disoccluded area (s_{F,l}′) and the detected object border misalignments;
determining a right reliability map information (s_{R,r}′) based on the right disoccluded area (s_{F,r}′), and the detected object border misalignments; and
computing the synthesized picture (s_{T}′) by merging a left projected picture (s_{T,l}′) of the left reference view and a right projected picture (s_{Tr}′) of the right reference view using the left (s_{R,l}′) and right (s_{R,r}′) reliability map information.

2. The method of claim 1, wherein determining the left reliability map information (s_{R,l}′) and the right reliability map information (s_{R,r}′) comprises:
determining the left reliability map information (s_{R,l}′) based on the left disoccluded area (s_{F,l}′) and the right reliability map information (s_{R,r}′) based on the right disoccluded area (s_{F,r}′); and
modifying at least one of the left reliability map information (s_{R,l}′) and the right reliability map information (s_{R,r}′) when object border misalignments between the left projected depth map and the right projected depth map are detected.

3. The method of claim 2, further comprising:
determining a plane discrimination map (s_{P,lr}′) between the left projected depth map (s_{D,r}′) and the right projected depth map (s_{D,r}′) based on the left projected depth map (s_{D,l}′) and the right projected depth map (s_{D,r}′);
determining a left plane discrimination map (s_{P,ll}′) for the left projected depth map (s_{D,l}′) based on the left projected depth map (s_{D,l}′); and
determining a right plane discrimination map (s_{P,rr}′) for the right projected depth map (s_{D,r}′) based on the right projected depth map (s_{D,r}′),
wherein determining the left reliability map information (s_{R,l}′) is based on the left plane discrimination map (s_{P,ll}′) and on the plane discrimination map (s_{P,lr}′), and
wherein determining the right reliability map information (s_{R,l}′) is based on the right plane discrimination map (s_{P,rr}′) and on the plane discrimination map (s_{P,lr}′).

4. The method of claim 1, wherein detecting object border misalignments comprises detecting whether samples in one of the left projected depth map (s_{D,l}′) and right projected depth map (s_{D,r}′) belong to an object border and at the same positions ((x,y)) belong to a foreground plane in the other projected depth map.

5. The method of claim 1, wherein an object border misalignment is detected when samples in a first of the left projected depth map (s_{D,l}′) and right projected depth map (s_{D,r}′) belong to an object border and at the same positions ((x,y)) belong to a foreground plane in the other second projected depth map of the left projected depth map (s_{D,l}′) and right projected depth map (s_{D,r}′), wherein determining the left reliability map information (s_{R,l}′) comprises assigning a reduced weight for samples in the left projected picture (s_{T,l}′) for the computing of the synthesized picture (s_{T}′) when the samples in the left projected depth map (s_{D,l}′) belong to an object border and at the same positions ((x,y)) belong to a foreground plane in the right projected depth map (s_{D,r}′), and wherein determining the right reliability map information (s_{R,l}′) comprises assigning a reduced weight for samples in the right projected picture (s_{T,r}′) for the computing of the synthesized picture (s_{T}′) when the samples in the right projected depth map (s_{D,r}′) belong to an object border and at the same positions ((x,y)) belong to a foreground plane in the left projected depth map (s_{D,l}′).

6. The method of claim 5, wherein the reduced weights are assigned according to a monotonically increasing or decreasing function over a transition region determined based on the positions of the samples belonging to the object border.

7. The method of claim 1, wherein determining the left reliability map information (s_{R,l}′) comprises assigning a reduced weight for samples in the left projected picture (s_{T,l}′) for the computing of the synthesized picture (s_{T}′), when a first sample (vₗ(x,y)) in the left projected depth map (s_{D,l}′) at a first position ((x,y)) does not belong to the left disoccluded area (s_{F,l}′), when a second right neighboring sample (vₗ(x+1,y)) to the first sample (vₗ(x,y)) in the left projected depth map (s_{D,l}′) belongs to the left disoccluded area (s_{F,l}′), when the first sample (vₗ(x,y)) in the left projected depth map (s_{D,l}′) and a first sample (vᵣ(x,y)) in the right projected depth map (s_{D,r}′) at the first position ((x,y)) belong to a same plane of the visual scene, and when the first sample (vᵣ(x,y)) in the right projected depth map (s_{D,r}′) and a second right neighboring sample (vᵣ(x+1,y)) to the first sample (vᵣ(x,y)) in the right projected depth map (s_{D,r}′) belong to the same plane of the visual scene.

8. The method of claim 1, wherein determining the left reliability map information (s_{R,l}′) comprises assigning a reduced weight for samples in the left projected picture (s_{T,l}′) for the computing of the synthesized picture (s_{T}′), when a first sample (vₗ(x,y)) in the left projected depth map (s_{D,l}′) at a first position ((x,y)) and a second left neighboring sample (vₗ(x−1,y) to the first left sample (vₗ(x,y)) in the left projected depth map do not belong to a same plane of the visual scene, when a point in the visual scene corresponding to the first sample (vₗ(x,y)) in the left projected depth map is closer to a camera than a point in the visual scene corresponding to the second left neighboring sample (vₗ(x−1,y)) in the left projected depth map, when the first sample (vₗ(x,y)) in the left projected depth map (s_{D,l}′) and a first sample (vᵣ(x,y)) in the right projected depth map (s_{D,r}′) at the first position ((x,y)) belong to a same plane of the visual scene, and when the first sample (vᵣ(x,y)) in the right projected depth map (s_{D,r}′) and a second left neighboring sample (vᵣ(x−1,y)) to the first sample (vᵣ(x,y)) in the right projected depth map (s_{D,r}′) belong to the same plane of the visual scene.

9. The method of claim 1, wherein object border misalignments are detected, and wherein determining the right reliability map information (s_{R,r}′) comprises assigning a reduced weight for samples in the right projected picture (s_{T,r}′) for the computing of the synthesized picture (s_{T}′), when a first sample (vᵣ(x,y)) in the right projected depth map (s_{D,r}′) at a first horizontal (x) and a first vertical (y) position does not belong to the right disoccluded area (s_{F,r}′), when a second left neighboring sample (vᵣ(x−1,y)) to the first sample (vᵣ(x,y)) in the right projected depth map (s_{D,r}′) belongs to the right disoccluded area (s_{F,r}′), when the first sample (vᵣ(x,y)) in the right projected depth map (s_{D,r}′) and a first sample (vₗ(x,y)) in the left projected depth map (s_{D,l}′) at the first horizontal (x) and the first vertical (y) position belong to a same plane of the visual scene, and when the first sample (vₗ(x,y)) in the left projected depth map (s_{D,l}′) and a second left neighboring sample (vₗ(x−1,y)) to the first sample (vₗ(x,y)) in the left projected depth map (s_{D,l}′) belong to the same plane of the visual scene.

10. The method of claim 1, wherein object border misalignments are detected, and wherein determining the right reliability map information (s_{R,r}′) comprises assigning a reduced weight for samples in the right projected picture (s_{T,r}′) for the computing of the synthesized picture (s_{T}′), when a first right sample (vᵣ(x,y)) in the right projected depth map (s_{D,r}′) at a first horizontal (x) and a first vertical (y) position and a second right neighboring sample (vᵣ(x+1,y) to the first sample (vᵣ(x,y)) in the right projected depth map (s_{D,r}′) do not belong to a same plane of the visual scene, when a point in the visual scene corresponding to the first sample (vᵣ(x,y)) in the right projected depth map (s_{D,r}′) is closer to a camera than a point in the visual scene corresponding to the second right neighboring sample (vᵣ(x+1,y)) in the right projected depth map (s_{D,r}′), when the first sample (vᵣ(x,y)) in the right projected depth map (s_{D,r}′) and a first sample (vₗ(x,y)) in the left projected depth map (s_{D,l}′) at the first horizontal (x) and the first vertical (y) position belong to a same plane of the visual scene, and when the first sample (vₗ(x,y)) in the left projected depth map (s_{D,l}′) and a second right neighboring sample (vₗ(x+1,y)) to the first sample (vₗ(x,y)) in the left projected depth map (s_{D,l}′) belong to the same plane of the visual scene.

11. The method of claim 1, wherein merging the left (s_{T,l}′) and right (s_{T,r}′) projected pictures comprises weighting a sample (vₗ(x,y)) in the left projected picture (s_{T,l}′) by the weight of the left reliability map (s_{R,l}′) and weighting a sample (vᵣ(x,y)) in the right projected picture (s_{T,r}′) by the weight of the right reliability map (s_{R,l}′).

12. The method of claim 11, further comprising combining the weighted sample (vₗ(x,y)) in the left projected picture (s_{T,l}′) and the weighted sample (vᵣ(x,y)) in the right projected picture (s_{T,r}′) to obtain a sample (v(x,y)) in the synthesized picture.

13. The method of claim 11, wherein, in case a sample (vₗ(x,y)) in the left projected picture (s_{T,l}′) and a sample (vᵣ(x,y)) in the right projected picture (s_{T,r}′) belong to different planes of the visual scene, the sample (v(x,y)) in the synthesized picture is calculated based only on which of the sample (vₗ(x,y)) in the left projected picture (s_{T,l}′) and the sample (vᵣ(x,y)) in the right projected picture (s_{T,r}′) belongs to the closer plane.

14. The method according to claim 1, wherein the left and right projected pictures are at least one of: projected texture pictures (s_{T,l}′, s_{T,r}′), the projected depth map pictures (s_{D,l}′, s_{D,r}′), and projected disparity pictures.

15. The method of claim 1, wherein the left depth map (s_{D,l}) of the left reference view of the visual scene is a left disparity map (s_{D,l}) of the left reference view of the visual scene, wherein the right depth map (s_{D,r}) of the right reference view of the visual scene is a right disparity map of the right view of the visual scene, and wherein the left projected depth map (s_{D,l}′) is a left projected disparity map and the right projected depth map (s_{D,r}′) is a right projected disparity map.

16. An apparatus for computing a synthesized picture (s_{T}′) of a visual scene based on a left depth map (s_{D,l}) of a left reference view of the visual scene and right depth map (s_{D,r}) of a right reference view of the visual scene, the apparatus comprising:
a projector configured to:
project the right depth map (s_{D,r}) into a right projected depth map (s_{D,r}′); and
determine a left disoccluded area (s_{F,l}′) in the left projected depth map (s_{D,l}′) and a right disoccluded area (s_{F,r}′) in the right projected depth map (s_{D,r}′);
a detector configured to detect object border misalignments between the left projected depth map (s_{D,l}′) and the right projected depth map (s_{D,r}′);
a determiner configured to:
determine a left reliability map information (s_{R,l}′) based on the left disoccluded area (s_{F,l}′) and the detected object border misalignments; and
determine a right reliability map information (s_{R,r}′) based on the right disoccluded area (s_{F,r}′) and the detected object border misalignments; and
a processor configured to compute the synthesized picture (s_{T}′) by merging a left projected picture (s_{T,l}′) of the left reference view and a right projected picture (s_{Tr}′) of the right reference view using the left (s_{R,l}′) and right (s_{R,r}′) reliability map information.
